(19) United States
(12) Patent Application Publication
(10) Pub. No.: US 2025/0264860 A1
(43) Pub. Date: Aug. 21, 2025

(54) METHOD AND SYSTEM FOR DETERMINING ABNORMALITY IN INDUSTRIAL MACHINE

(71) Applicant: KOMATSU INDUSTRIES CORPORATION, Kanazawa-shi, Ishikawa (JP)

(72) Inventors: Yusuke MASATO, Ishikawa (JP); Eiji DOBA, Ishikawa (JP); Shinya OHZEKI, Ishikawa (JP); Kazuhisa ANADA, Ishikawa (JP)

(21) Appl. No.: 18/857,321

(22) PCT Filed: Jun. 2, 2023
(86) PCT No.: PCT/JP2023/020654

§ 371 Date: Oct. 16, 2024

(30) Foreign Application Priority Data
Jul. 26, 2022 (JP) 2022-118821

(51) Int. Cl. G05B 19/4065; G05B 19/416

(52) U.S. Cl. CPC G05B 19/4065; G05B 19/4166

(57) ABSTRACT

A method of determining synchronization deviation includes acquiring first drive data indicative of a dynamic state of a first drive mechanism, acquiring second drive data indicative of a dynamic state of a second drive mechanism, extracting differences between the first drive data and the second drive data, deriving a cumulative sum of the differences, determining whether the cumulative sum exhibits linearity or non-linearity, and determining that the synchronization deviation has occurred between the first drive mechanism and the second drive mechanism when the cumulative sum exhibits non-linearity.

### CROSS-REFERENCE TO RELATED APPLICATIONS

This application is a U.S. National stage application of International Application No. PCT/JP2023/020654, filed on Jun. 2, 2023. This U.S. National stage application claims priority under 35 U.S.C. § 119 (a) to Japanese Patent Application No. 2022-118821, filed in Japan on Jul. 26, 2022, the entire contents of which are hereby incorporated herein by reference.

### TECHNICAL FIELD

The present disclosure relates to a method and a system for determining abnormality in an industrial machine.

### BACKGROUND ART

Detecting the occurrence of abnormalities may be desired in an industrial machine. As a result, in the prior art, an abnormality is determined by detecting a predetermined output value of the industrial machine with a sensor and comparing the detected output value with a threshold (for example, see Japanese Patent Laid-open No. H02-195498).

However, a pair of drive mechanisms that operate together in synchronization are provided to an industrial machine. For example, Japanese Patent No. 4198035 discloses a workpiece feeding device in a press line. The workpiece feeding line includes a cross bar, a pair of swinging bodies, and the pair of drive mechanisms. The pair of swinging bodies are respectively connected to the left and right end parts of the cross bar. The pair of drive mechanisms move the pair of swinging bodies.

### SUMMARY

The pair of drive mechanisms in the above-mentioned workpiece feeding device both have the same structure and operate the pair of swinging bodies in synchronization. However, the synchronization of the pair of drive mechanisms may deviate. When a deviation in the synchronization of the pair of drive mechanisms occurs, it is difficult to operate the workpiece feeding device with accuracy. While the presence or absence of abnormalities can be detected for each of the pair of drive mechanisms in the above-mentioned conventional abnormality detection methods, it is difficult to detect a deviation of the synchronization of the pair of drive mechanisms. An object of the present is to accurately detect a synchronization deviation in an industrial machine that includes a pair of drive mechanisms that operate together in synchronization.

A method according to one aspect of the present disclosure is executed by a one or more computers for determining synchronization deviation between a first drive mechanism and a second drive mechanism in an industrial machine including the first drive mechanism and the second drive mechanism that operate together in synchronization. The method includes acquiring first drive data that indicates a dynamic state of the first drive mechanism, acquiring second drive data that indicates a dynamic state of the second drive mechanism, extracting differences between the first drive data and the second drive data, deriving a cumulative sum of the differences, determining whether the cumulative sum exhibits linearity or non-linearity, and determining that synchronization deviation has occurred between the first drive mechanism and the second drive mechanism when the cumulative sum exhibits non-linearity.

A system according to another aspect of the present disclosure is for determining synchronization deviation between a first drive mechanism and a second drive mechanism in an industrial machine including the first drive mechanism and the second drive mechanism that operate together in synchronization. The system includes a storage device and one or more computers. The storage device stores first drive data that indicates a dynamic state of the first drive mechanism and second drive data that indicates a dynamic state of the second drive mechanism. The one or more computers are communicably connected to the storage device. The one or more computers extract differences between the first drive data and the second drive data. The one or more computers derive a cumulative sum of the differences. The one or more computers determine whether the cumulative sum exhibits linearity or non-linearity. The one or more computers determine that synchronization deviation between the first drive mechanism and the second drive mechanism has occurred when the cumulative sum exhibits non-linearity.

According to the present disclosure, deviation of synchronization is accurately detected in the industrial machine including the pair of drive mechanisms that operate together in synchronization.

### BRIEF DESCRIPTION OF DRAWINGS

FIG. 1 is a schematic view of a predictive maintenance system according to an embodiment.

FIG. 2 is a front view of an industrial machine.

FIG. 3 is a front view illustrating a workpiece feeding device.

FIG. 4 is a side view illustrating a first drive mechanism.

FIG. 5 is a flow chart illustrating processing for a predictive maintenance service for the workpiece feeding device.

FIG. 6 is a flow chart illustrating processing for the predictive maintenance service for the workpiece feeding device.

FIG. 7A illustrates an example of first drive data.

FIG. 7B illustrates an example of second drive data.

FIG. 8 illustrates an example of difference data of the first drive data and the second drive data.

FIG. 9A illustrates an example of analysis data.

FIG. 9B illustrates an example of a Gaussian distribution of the analysis data.

FIG. 10 illustrates an example of cumulative sum data indicating that there is no synchronization deviation.

FIG. 11 illustrates an example of cumulative sum data indicating that there is synchronization deviation.

### DESCRIPTION OF EMBODIMENTS

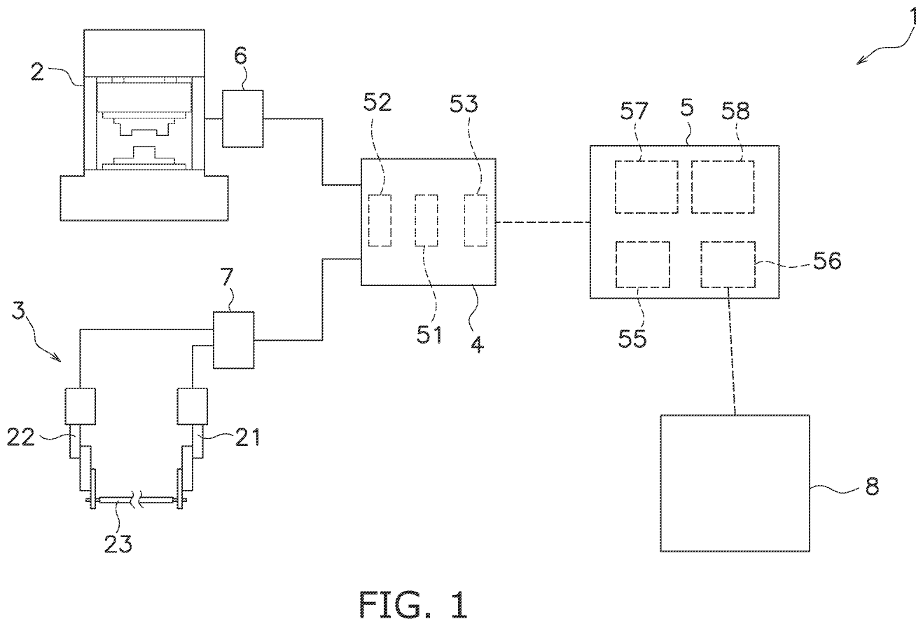

The following is an explanation of an embodiment with reference to the drawings. FIG. 1 is a schematic view of a predictive maintenance system 1 according to the embodiment. The predictive maintenance system 1 is a system for determining locations to be subjected to maintenance before the occurrence of a failure in an industrial machine. The predictive maintenance system 1 includes industrial machines 2 and 3, a local computer 4, and a server 5.

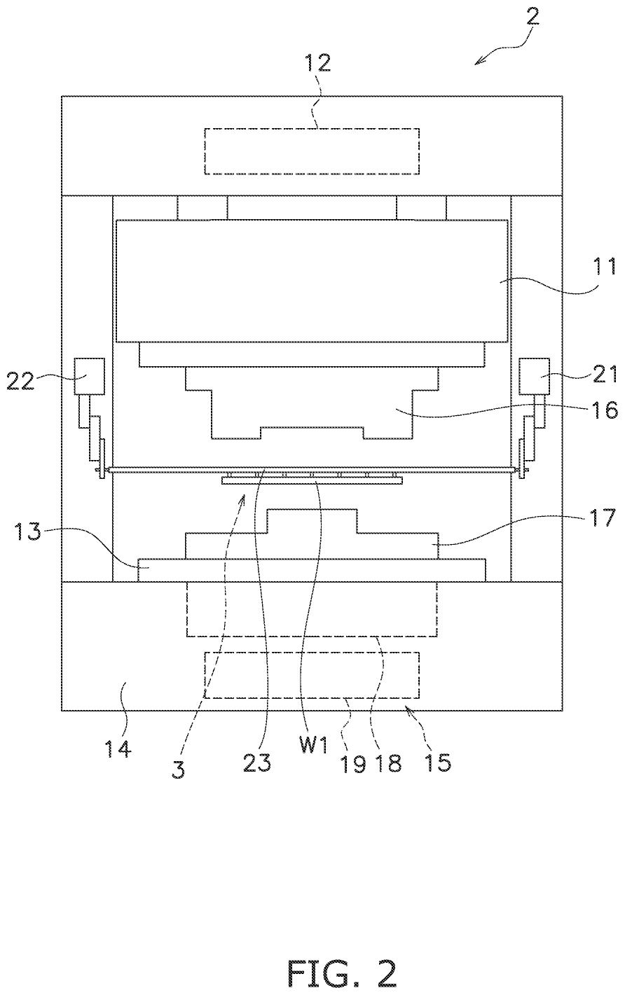

As illustrated in FIG. 1, the industrial machines 2 and 3 include a press machine 2 and a workpiece feeding device 3. FIG. 2 is a front view of the industrial machines 2 and 3. The press machine 2 includes a slider 11, a slide drive mechanism 12, a bolster 13, a bed 14, a die cushion device 15, and a press controller 6. The slider 11 is configured to move up and down. An upper die 16 is attached to the slider 11. The slide drive mechanism 12 causes the slider 11 to operate. The slide drive mechanism 12 includes, for example, a servomotor.

The bolster 13 is disposed below the slider 11. A lower die 17 is attached to the bolster 13. The bed 14 is disposed below the bolster 13. The die cushion device 15 applies an upward load to the lower die 17 during pressing. Specifically, the die cushion device 15 applies an upward load to the lower die 17 during pressing. The press controller 6 controls the operations of the slider 11 and the die cushion device 15.

The die cushion device 15 includes a cushion pad 18 and a die cushion drive mechanism 19. The cushion pad 18 is disposed below the bolster 13. The cushion pad 18 is configured to move up and down. The die cushion drive system 19 causes the cushion pad 18 to operate vertically. The die cushion drive mechanism 19 includes, for example, a servomotor.

The slide drive mechanism 12 and the die cushion drive mechanism 19 are connected to the press controller 6. The press controller 6 includes a processor and a memory that are not illustrated. The slide drive mechanism 12 and the die cushion drive mechanism 19 are controlled by the press controller 6. Consequently, a workpiece W1 is pressed by the upper die 16 and the lower die 17.

The workpiece feeding device 3 feeds the workpiece W1 to be pressed. The workpiece feeding device 3 moves the workpiece W1 in the feeding direction. The feeding direction is a direction perpendicular to the page of FIG. 2. The direction perpendicular to the page of FIG. 2 is defined as the front-back direction of the workpiece feeding device 3. The left-right direction in FIG. 2 is defined as the left-right direction of the workpiece feeding device 3.

For example, the above-mentioned press machine 2 is a portion of a transfer press includes a plurality of press machines and the plurality of press machines are disposed side by side in the front-back direction. The workpiece feeding device 3 feeds the workpiece W1 to be pressed in the press machine 2 to a processing position in another press machine. As illustrated in FIG. 2, the workpiece feeding device 3 includes a first drive mechanism 21, a second drive mechanism 22, and a cross bar 23.

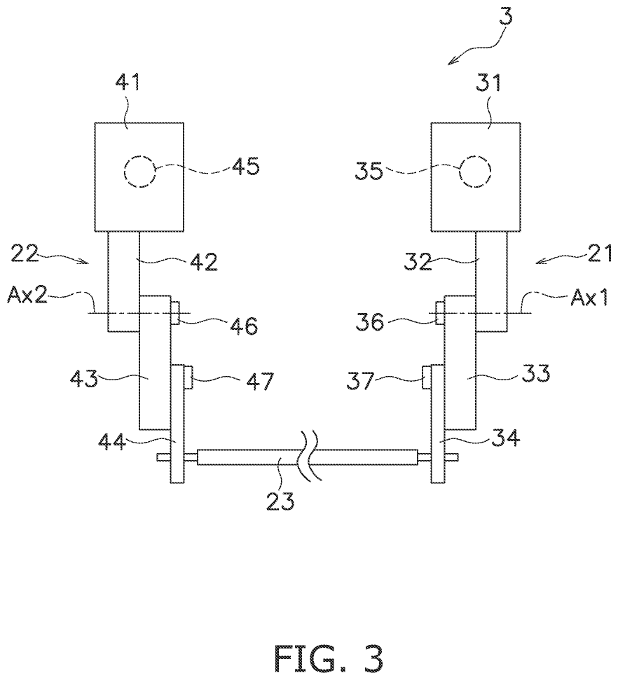

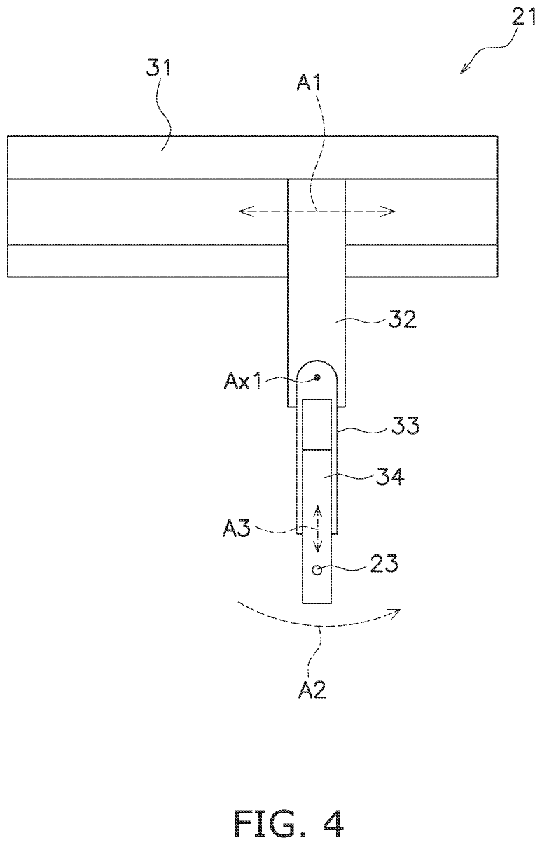

FIG. 3 is a front view illustrating the workpiece feeding device 3. FIG. 4 is a side view illustrating the first drive mechanism 21. As illustrated in FIGS. 3 and 4, the first drive mechanism 21 includes a first rail 31, a first linear arm 32, a first swing arm 33, and a first slider arm 34. The first rail 31 extends in the front-back direction. The first linear arm 32 is supported by the first rail 31. As illustrated by arrow A1 in FIG. 4, the first linear arm 32 is movable in the front-back direction along the first rail 31. The first swing arm 33 is connected to the first linear arm 32. As illustrated by arrow A2 in FIG. 4, the first swing arm 33 is swingable about a first axis Ax1 with respect to the first linear arm 32. The first slider arm 34 is connected to the first swing arm 33. As illustrated by arrow A3 in FIG. 4, the first slider arm 34 is movable along the first swing arm 33.

The first drive mechanism 21 includes a first linear motor 35, a first swing motor 36, and a first slider motor 37. The first linear motor 35 causes the first linear arm 32 to operate. The first swing motor 36 causes the first swing arm 33 to operate. The first slider motor 37 causes the first slider arm 34 to operate. Specifically, the first linear motor 35 moves the first linear arm 32 along the first rail 31. The first swing motor 36 swings the first swing arm 33 about the first axis Ax1. The first slider motor 37 moves the first slider arm 34 along the first swing arm 33.

The second drive mechanism 22 is disposed away from the first drive mechanism 21 in the left-right direction. The second drive mechanism 22 has a structure that has left-right symmetry with the first drive mechanism 21. The second drive mechanism 22 includes a second rail 41, a second linear arm 42, a second swing arm 43, and a second slider arm 44. The second rail 41 extends in the front-back direction. The second linear arm 42 is supported by the second rail 41. The second linear arm 42 is movable in the front-back direction along the second rail 41. The second swing arm 43 is connected to the second linear arm 42. The second swing arm 43 is swingable about a second axis Ax2 with respect to the second linear arm 42. The second slider arm 44 is connected to the second swing arm 43. The second slider arm 44 is movable along the second swing arm 43.

The second drive mechanism 22 includes a second linear motor 45, a second swing motor 46, and a second slider motor 47. The second linear motor 45 causes the second linear arm 42 to operate. The second swing motor 46 causes the second swing arm 43 to operate. The second slider motor 47 causes the second slider arm 44 to operate. Specifically, the second linear motor 45 moves the second linear arm 42 along the second rail 41. The second swing motor 46 moves the second swing arm 43 about the second axis Ax2. The second slider motor 47 moves the second slider arm 44 along the second swing arm 43.

The cross bar 23 holds the workpiece W1. The cross bar 23 extends in the left-right direction between the first drive mechanism 21 and the second drive mechanism 22. One end of the cross bar 23 is connected to the first slider arm 34. The other end of the cross bar 23 is connected to the second slider arm 44. Vacuum cups, for example, are attached to the cross bar 23 and hold the workpiece W1 by suction.

As illustrated in FIG. 1, the workpiece feeding device 3 includes a feeder controller 7. The feeder controller 7 includes a processor and a memory that are not illustrated. The above-mentioned motors 35 to 37 and 45 to 47 are each servomotors. The feeder controller 7 controls the motors 35 to 37 and 45 to 47 thereby causing the first drive mechanism 21 and the second drive mechanism 22 to operate in synchronization. Specifically, the feeder controller 7 causes the first linear motor 35 and the second linear motor 45 to operate in synchronization. The feeder controller 7 causes the first swing motor 36 and the second swing motor 46 to operate in synchronization. The feeder controller 7 causes the first slider motor 37 and the second slider motor 47 to operate in synchronization. Consequently, the first drive mechanism 21 and the second drive mechanism 22 operate in synchronization and the workpiece W1 is fed by the cross bar 23 moving in the feeding direction.

The local computer 4 communicates with the press controller 6 and the feeder controller 7. As illustrated in FIG. 1, the local computer 4 includes a processor 51, a storage device 52, and a communication device 53. The processor 51 is, for example, a central processing unit (CPU). Alternatively, the processor 51 may be a processor different from a CPU.

The storage device 52 includes a non-volatile memory, such as a ROM, and a volatile memory, such as a RAM. The storage device 52 may include an auxiliary storage device, such as a hard disk or a solid state drive (SSD). The storage device 52 is an example of a non-transitory computer-readable recording medium. The storage device 52 stores computer commands and data for controlling the local computer 4. The communication device 53 communicates with the server 5.

The server 5 collects data for predictive maintenance from the workpiece feeding device 3 via the local computer 4. The server 5 executes the predictive maintenance service based on the collected data. The server 5 communicates with a client computer 8. The server 5 provides the predictive maintenance service to the client computer 8. The predictive maintenance service is explained below.

The server 5 includes a first communication device 55, a second communication device 56, a processor 57, and a storage device 58. The first communication device 55 communicates with the local computer 4. The second communication device 56 communicates with the client computer 8. The processor 57 is, for example, a central processing unit (CPU). Alternatively, the processor 57 may be a processor different from a CPU. The processor 57 executes a process for the predictive maintenance service according to a program.

The storage device 58 includes a non-volatile memory, such as a ROM, and a volatile memory, such as a RAM. The storage device 58 may include an auxiliary storage device, such as a hard disk or a solid state drive (SSD). The storage device 58 is an example of a non-transitory computer-readable recording medium. The storage device 58 stores computer commands and data for controlling the server 5.

The above-mentioned communication may be performed over a mobile communication network, such as 3G, 4G, or 5G. Alternatively, the communication may be performed over another wireless communication network, such as by satellite communication. Alternatively, the communication may be performed via a computer communication network, such as a LAN, a VPN, or the Internet. Alternatively, the communication may be performed over a combination of any of the above communication networks.

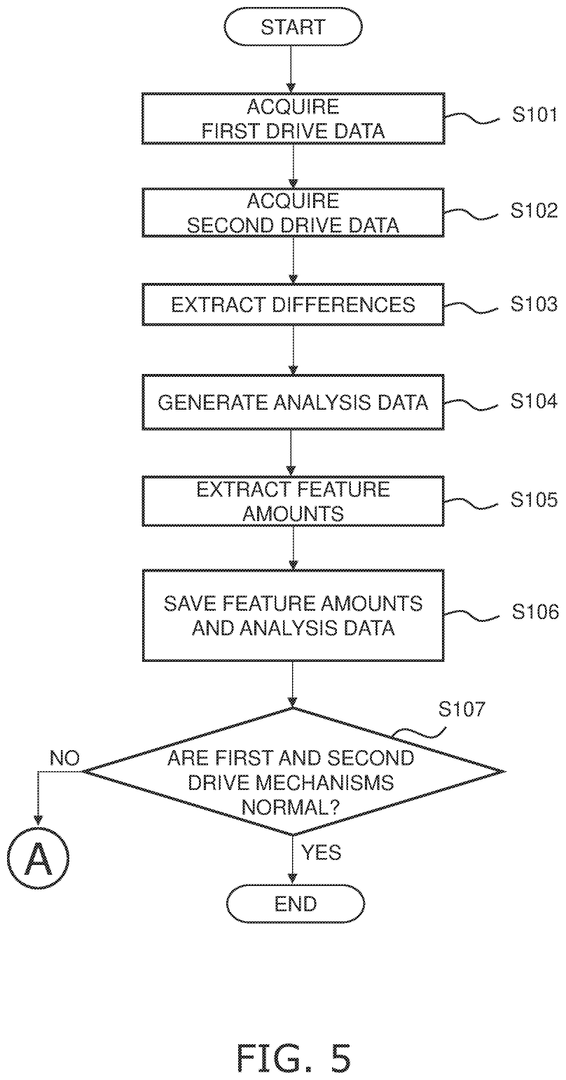

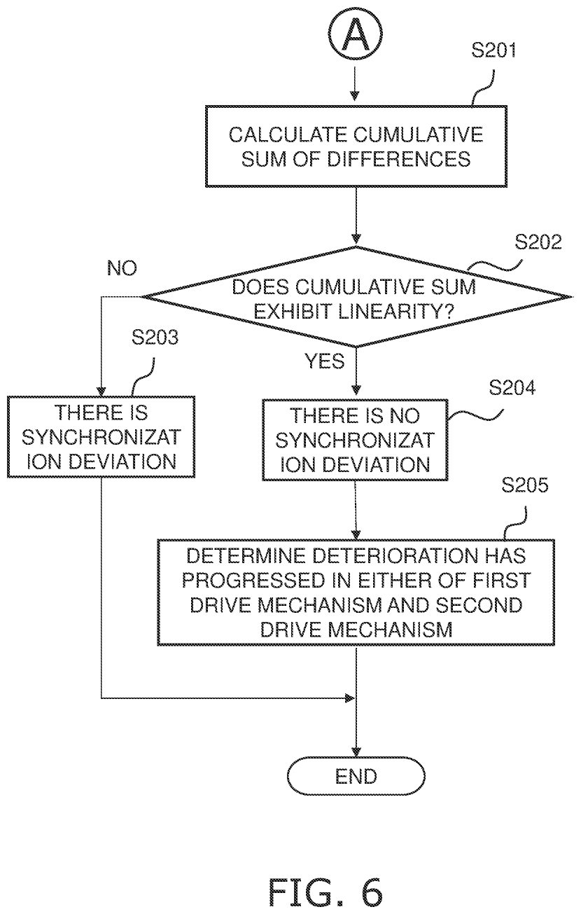

Next, processing for the predictive maintenance service on the workpiece feeding device 3 will be explained. FIGS. 5 and 6 are flow charts illustrating processing for the predictive maintenance service for the workpiece feeding device 3. As illustrated in FIG. 5, the server 5 acquires first drive data in step S101. The first drive data is transmitted from the feeder controller 7 to the local computer 4. The server 5 receives the first drive data from the local computer 4 and saves the first drive data in the storage device 58.

The first drive data indicates a dynamic state of the first drive mechanism 21. The first drive data includes, for example, the motor torque of the first slider motor 37. The first slider motor 37 is subjected to feedback control by the feeder controller 7 and the motor torque of the first slider motor 37 is indicated, for example, with torque command values from the feeder controller 7 to the first slider motor 37. The feeder controller 7 acquires the motor torque of the first slider motor 37 in a predetermined sampling period. The sample number is, for example, several hundred to several thousand but is not limited thereto. The first drive data includes a plurality of motor torques sampled over a predetermined time period.

In step S102, the server 5 acquires second drive data. The second drive data is transmitted from the feeder controller 7 to the local computer 4. The server 5 receives the second drive data from the local computer 4 and saves the second drive data in the storage device 58. The second drive data indicates a dynamic state of the second drive mechanism 22. The second drive data includes, for example, the motor torque of the second slider motor 47. The second slider motor 47 is subjected to feedback control by the feeder controller 7 and the motor torque of the second slider motor 47 is indicated, for example, with torque command values from the feeder controller 7 to the second slider motor 47.

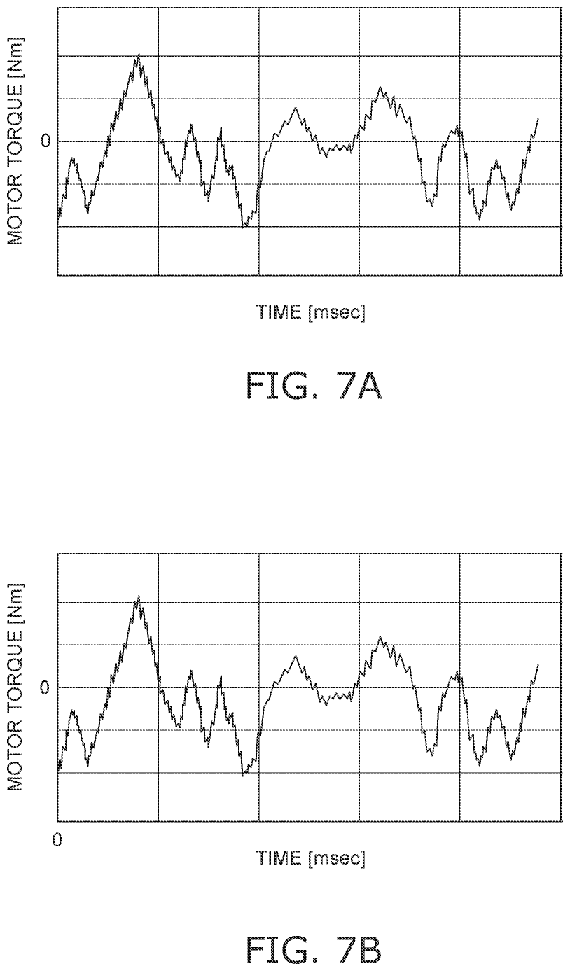

FIG. 7A illustrates an example of the first drive data. The first drive data in FIG. 7A depicts the motor torque waveform of the first slider motor 37. The server 5 acquires the motor torque waveform of the first slider motor 37 as the first drive data. FIG. 7B illustrates an example of the second drive data. The second drive data in FIG. 7B depicts the motor torque waveform of the second slider motor 47. The server 5 acquires the motor torque waveform of the second slider motor 47 as the second drive data.

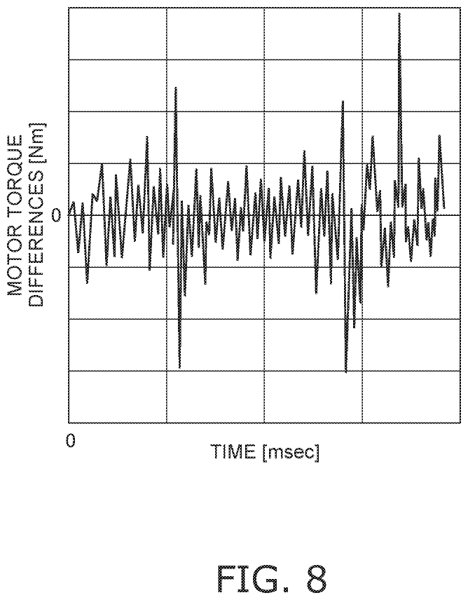

In step S103, the server 5 extracts differences between the first drive data and the second drive data. The server 5 extracts the difference between the motor torques of the first slider motor 37 and the second slider motor 47 at the same time from the first drive data and the second drive data. The server 5 saves the extracted differences in the storage device 58 as difference data. The difference data includes a plurality of difference values of the motor torques sampled over a predetermined time period. FIG. 8 illustrates an example of the difference data of the first slider motor 37 and the second slider motor 47.

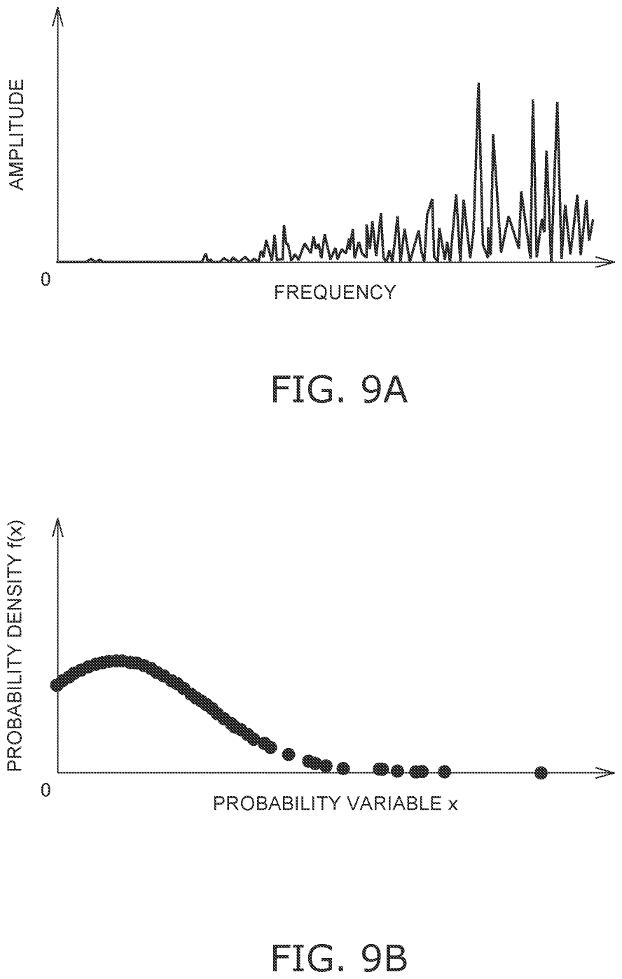

In step S104, the server 5 generates analysis data. The server 5 generates the analysis data from the difference data by Fast Fourier transform. FIG. 9A illustrates an example of the analysis data. In FIG. 9A, the horizontal axis is the frequency and the vertical axis is the amplitude. The analysis data represents a power spectrum value for each frequency of the Fast Fourier transform.

In step S105, the server 5 extracts feature amounts from the analysis data. The server 5 acquires, as the feature amounts, an average and a standard deviation of the analysis data by performing Gaussian distribution on the analysis data. FIG. 9B illustrates an example of a Gaussian distribution of the analysis data. In FIG. 9B, the horizontal axis is a probability variable x and represents a power spectrum value. The vertical axis represents a probability density f(x). The probability density f(x) is expressed with the following formula (1). In formula (1), “μ” is the average. “σ” is the standard deviation.

$$f ( x ) = \frac{1}{\sqrt{2 π} σ} exp ( - \frac{{( x - μ )}^{2}}{2 {σ}^{2}} ) \qquad ( 1 )$$

In step S106, the server 5 saves the analysis data and the feature amounts μ and σ in the storage device 58. As illustrated in FIG. 6, the server 5 determines whether the first and second drive mechanisms 21 and 22 are normal in step S107. The server 5 determines whether the first slider motor 37 and the second slider motor 47 are normal from the feature amounts μ and σ corresponding to the difference data of the first slider motor 37 and the second slider motor 47. The determination of whether the first slider motor 37 and the second slider motor 47 are normal may be performed by a well-known method in quality engineering.

For example, the server 5 determines whether the first slider motor 37 and the first slider arm 34 and the second slider motor 47 and the second slider arm 44 are normal by using the Mahalanobis-Taguchi method (MT method). In this case, the server 5 calculates the Mahalanobis distances of the feature amounts μ and σ received from the server 5 based on the feature amount μ and σ when the first slider motor 37 and the first slider arm 34 and the second slider motor 47 and the second slider arm 44 are normal. The server 5 determines that at least one of the first slider motor 37 and the first slider arm 34 and the second slider motor 47 and the second slider arm 44 is not normal when the Mahalanobis distances are greater than a threshold. However, the server 5 may determine whether the first and second drive mechanisms are normal using another method.

When the server 5 determines that the first slider motor 37 and the second slider motor 47 are not normal in step S107, the processing advances to step S201 in FIG. 6. The fact that the first slider motor 37 and the second slider motor 47 are not normal signifies a state in which the first slider motor 37 and the second slider motor 47 have not failed yet but deterioration has progressed a certain extent.

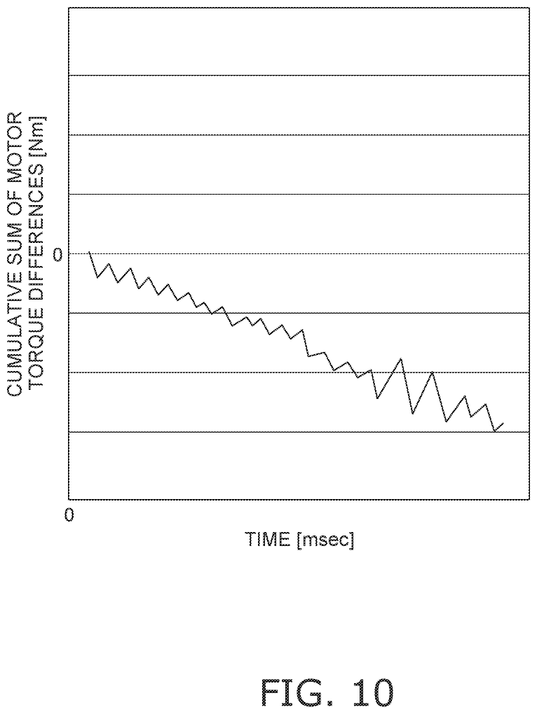

In step S201, the server 5 calculates the cumulative sum of the differences. The server 5 derives the cumulative sum of the differences of the motor torque of the first slider motor 37 and the second slider motor 47 from the above-mentioned difference data of the first slider motor 37 and the second slider motor 47. FIG. 10 illustrates an example of cumulative sum data that indicates the cumulative sum of the differences.

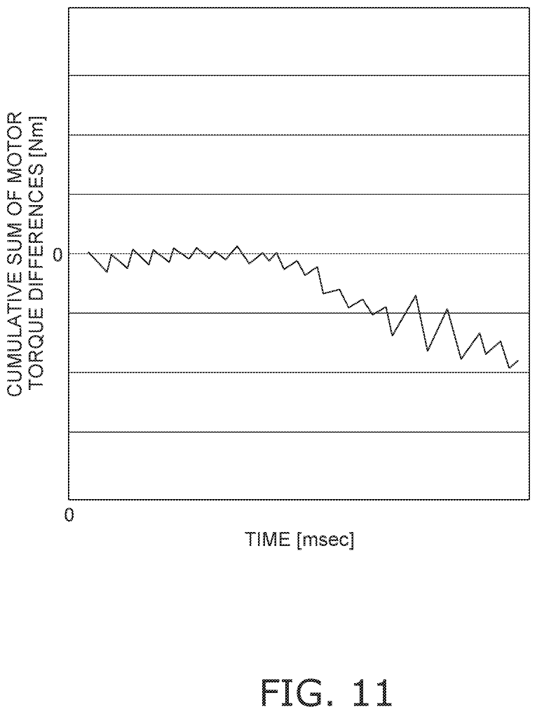

In step S202, the server 5 determines whether the cumulative sum exhibits linearity. The server 5 determines whether the cumulative sum exhibits linearity based on, for example, a well-known determination method for linearity. As illustrated in FIGS. 10 and 11, the server 5 determines whether changes of the cumulative sum over time exhibit linearity or non-linearity. As in indicator of linearity, for example, the server 5 determines that linearity is exhibited when the residual sum of squares (RSS) between a data interpolation line and the data is 2.0 to 3.0 or less. However, the numerical value of the indicator of the linearity is not limited thereto and may be a value suited to a model for analysis. FIG. 10 illustrates the cumulative sum data that exhibits linearity. FIG. 11 illustrates the cumulative sum data that does not exhibit linearity. When the cumulative sum does not exhibit linearity as illustrated in FIG. 11, the server 5 determines that there is synchronization deviation between the first drive mechanism 21 and the second drive mechanism 22 in step S203.

When the cumulative sum exhibits linearity as illustrated in FIG. 10, the server 5 determines that there is no synchronization deviation between the first drive mechanism 21 and the second drive mechanism 22 in step S204. In step S205, the server 5 determines that deterioration has progressed in either the first drive mechanism 21 or the second drive mechanism 22.

The server 5 performs the same processing on the first drive data pertaining to the first linear motor 35 and the second drive data pertaining to the second linear motor 45. The server 5 also performs the same processing on the first drive data pertaining to the first swing motor 36 and the second drive data pertaining to the second swing motor 46. Consequently, the server 5 determines whether there is synchronization deviation in the first drive mechanism 21 and the second drive mechanism 22. The server 5 also determines whether deterioration has progressed in either the first drive mechanism 21 or the second drive mechanism 22.

The server 5 provides the results of the above determination as the predictive maintenance service to the client computer 8. For example, the server 5 transmits the results of the determination to the client computer 8 by email. Alternatively, the server 5 may display the determination results on a management screen displayed by a web browser.

In the system according to the present embodiment explained above, a determination is made as to whether the cumulative sum of the differences between the first drive data and the second drive data exhibits linearity or non-linearity. When the cumulative sum exhibits non-linearity, the occurrence of synchronization deviation between the first drive mechanism 21 and the second drive mechanism 22 is determined. Consequently, the deviation of synchronization is detected with accuracy in the workpiece feeding device 3 that includes the first drive mechanism 21 and the second drive mechanism 22 that operate together in synchronization.

Although an embodiment of the present disclosure has been described so far, the present disclosure is not limited to the above embodiment and various modifications may be made within the scope of the disclosure. For example, the above-mentioned processing for the predictive maintenance service is not limited to the workpiece feeding device 3 and may be performed on the press machine 2. Alternatively, the industrial machine is not limited to the press machine 2 and the workpiece feeding device 3 and may include another machine, such as a welding machine or a cutting machine, or may include a workpiece feeding device used with such machines.

The configuration of the workpiece feeding device 3 may be changed. For example, a portion of the above-mentioned motors may be omitted. Alternatively, a motor may be added. The configuration of the server 5 may be changed. For example, the server 5 may include a plurality of computers. Processing performed with the above-mentioned server 5 may be distributed among the plurality of computers and executed. The server 5 may include a plurality of processors. A portion or all of the processing performed by the server 5 may be executed by the local computer 4. For example, the processing of steps S101 to S105 may be executed by the local computer 4.

A portion of the above-mentioned processing may be omitted or changed. The order of the above-mentioned processing may be changed. The method for determining the abnormality by means of the analysis data is not limited to that of the above embodiment and may be changed. The feature amount may include only one of the average μ and standard deviation σ of the Gaussian distribution. The analysis data is not limited to Fast Fourier transform and may be acquired with another frequency analysis, such as discrete Fourier transform.

The first drive data and the second drive data are not limited to the command values of the motor torques. The first drive data and the second drive data may be other parameters, such as the current values of the motors, the positions of the motors, or the rotation speeds of the motors, that indicate dynamic states of the first drive mechanism and the second drive mechanism.

According to the present disclosure, deviation of synchronization is accurately detected in the industrial machine including the pair of drive mechanisms that operate together in synchronization.

1. A method executed by one or more computers for determining synchronization deviation between a first drive mechanism and a second drive mechanism in an industrial machine including the first drive mechanism and the second drive mechanism that operate together in synchronization, the method comprising:
acquiring first drive data indicative of a dynamic state of the first drive mechanism;
acquiring second drive data indicative of a dynamic state of the second drive mechanism;
extracting differences between the first drive data and the second drive data;
deriving a cumulative sum of the differences;
determining whether the cumulative sum exhibits linearity or non-linearity; and
determining that the synchronization deviation occurs between the first drive mechanism and the second drive mechanism when the cumulative sum exhibits non-linearity.

2. The method according to claim 1, further comprising
performing frequency analysis on difference data indicative of the differences to acquire analysis data indicative of a power spectrum of the difference data;
deriving a Gaussian distribution of the analysis data and acquiring feature amounts representing the Gaussian distribution; and
determining whether the first drive mechanism and the second drive mechanism are abnormal based on the feature amounts.

3. The method according to claim 2, further comprising
determining that the first drive mechanism and the second drive mechanism are abnormal based on the feature amounts, and
determining that deterioration of either of the first drive mechanism and the second drive mechanism is progressing when a determination is made that the cumulative sum exhibits linearity.

4. The method according to claim 1, wherein
the first drive mechanism includes a first motor,
the second drive mechanism includes a second motor,
the first drive data indicates a torque waveform of the first motor, and
the second drive data indicates a torque waveform of the second motor.

5. The control system according to claim 5, wherein
the industrial machine is a workpiece feeding device that feeds a workpiece to be pressed.

6. The method according to claim 5, wherein
the industrial machine further includes
a cross bar extending between the first drive mechanism and the second drive mechanism, the cross bar being configured to hold the workpiece,
the first drive mechanism includes
a first arm connected to one end of the cross bar, and
a first motor configured to cause the first arm to operate, and
the second drive mechanism includes
a second arm connected to the other end of the cross bar, and
a second motor configured to cause the second arm to operate.

7. A system for determining synchronization deviation between a first drive mechanism and a second drive mechanism in an industrial machine including the first drive mechanism and the second drive mechanism that operate together in synchronization, the system comprising:
a storage device configured to store first drive data indicative of a dynamic state of the first drive mechanism and second drive data indicative of a dynamic state of the second drive mechanism; and
one or more computers communicably connected to the storage device, the one or more computers being configured to
extract differences between the first drive data and the second drive data,
derive a cumulative sum of the differences,
determine whether the cumulative sum exhibits linearity or non-linearity, and
determine that the synchronization deviation occurs between the first drive mechanism and the second drive mechanism when the cumulative sum exhibits non-linearity.

8. The system according to claim 7, wherein
the one or more computers is further configured to
perform frequency analysis on difference data indicative of the differences to acquire analysis data indicative of a power spectrum of the difference data,
derive a Gaussian distribution of the analysis data and acquire feature amounts representing the Gaussian distribution, and
determine whether the first drive mechanism and the second drive mechanism are abnormal based on the feature amounts.

9. The system according to claim 8, wherein
the one or more computers is further configured to
determine that the first drive mechanism and the second drive mechanism are abnormal based on the feature amounts, and determine that deterioration of either of the first drive mechanism and the second drive mechanism is progressing when a determination is made that the cumulative sum exhibits linearity.

10. The system according to claim 7, wherein
the first drive mechanism includes a first motor,
the second drive mechanism includes a second motor,
the first drive data indicates a torque waveform of the first motor, and
the second drive data indicates a torque waveform of the second motor.

11. The method according to claim 7, wherein
the industrial machine is a workpiece feeding device that feeds a workpiece to be pressed.

12. The system according to claim 11, wherein
the industrial machine further includes
a cross bar extending between the first drive mechanism and the second drive mechanism, the cross bar being configured to hold the workpiece,
the first drive mechanism includes
a first arm connected to one end of the cross bar, and
a first motor configured to cause the first arm to operate, and
the second drive mechanism includes
a second arm connected to the other end of the cross bar, and
a second motor configured to cause the second arm to operate.
